(19) United States
(12) Patent Application Publication
(10) Pub. No.: US 2017/0113517 A1
(43) Pub. Date: Apr. 27, 2017

(54) AUTOMATIC DUST REMOVAL DEVICE FOR VEHICLE

(71) Applicant: Hyundai Motor Company, Seoul (KR)

(72) Inventors: Dong Ho Kwon, Anyang (KR); Dong Won Yeon, Hwaseong (KR); Kwang Woon Cho, Yongin (KR); Gee Young Shin, Suwon (KR)

(21) Appl. No.: 15/205,278

(22) Filed: Jul. 8, 2016

(30) Foreign Application Priority Data
Oct. 27, 2015 (KR) 10-2015-0149312

(51) Int. Cl. B60H 3/06; B01D 46/00; B01D 46/46; B01D 46/42; B60H 1/00; B01D 46/44

(52) U.S. Cl. CPC B60H 3/06; B60H 1/00785; B60H 1/008; B60H 1/00864; B60H 1/00771; B01D 46/442; B01D 46/46; B01D 46/429; B01D 46/0091; B01D 46/0041; B60H 2003/0683; B01D 2279/40

(57) ABSTRACT

An automatic dust removal device for a vehicle is provided. The device constantly senses dust in the interior of the vehicle and automatically removes the detected dust. The device includes a dust sensor that senses dust concentration in the interior of the vehicle and a controller that operates an air-conditioning device. The controller determines whether dust in the interior of the vehicle requires removal based on a signal from the dust sensor. An air-conditioning device for removing dust from the air is operated to activate a dust removal mode based on a signal from the controller. Thus, an intake door is closed to block inflow of external air into the interior of the vehicle and the air in the interior of the vehicle passes through an air filter and is circulated by a blower.

### CROSS-REFERENCE TO RELATED APPLICATION

This application claims under 35 U.S.C. §119(a) the benefit of priority to Korean Patent Application No. 10-2015-0149312 filed on Oct. 27, 2015, the entire contents of which are incorporated herein by reference.

### BACKGROUND

(a) Technical Field

The present disclosure relates to an automatic dust removal device for a vehicle, and more particularly, to an automatic dust removal device for a vehicle, which constantly senses dust within the vehicle and automatically removes the detected dust.

(b) Background Art

The interior of a vehicle is easily contaminated since it is a confined and sealed space. Unless the interior of the vehicle is periodically ventilated to remove the contaminated air, such indoor air contamination is worsened by dust and various contaminants introduced into the interior of the vehicle. Typically, a driver manually opens the window or the door to ventilate the interior of the vehicle. However, the window or the door is not always convenient to open due to potential weather restrictions. Further, when the atmosphere is contaminated with dust and various contaminants, opening the window or the door has an adverse effect since the dust and the various contaminants in the atmosphere enter the interior of the vehicle.

Therefore, a new technology is demanded to ventilate the interior of the vehicle when the window and the door are closed. Meanwhile, a vehicle is equipped with an air-conditioning device to maintain suitable indoor temperature, humidity, air cleanliness and air flow. When it is intended to ventilate the interior of the vehicle while traveling, the external air is introduced into the interior of the vehicle by vehicle-induced wind or through a blower. However, since the indoor ventilation using the air-conditioning device is achieved by user manipulation, the indoor ventilation is not executed until the necessity to ventilate the interior of the vehicle is determined by a user. Therefore, it may be difficult to actively respond to the situation in which the level of air contamination in the interior of the vehicle is increased.

The above information disclosed in this section is merely for enhancement of understanding of the background of the invention and therefore it may contain information that does not form the prior art that is already known in this country to a person of ordinary skill in the art.

### SUMMARY

The present invention provides an automatic dust removal device for a vehicle, which constantly senses dust in the interior of the vehicle and automatically removes the detected dust.

In one aspect, the present invention provides an automatic dust removal device for a vehicle that may include a dust sensor configured to sense dust concentration in an interior of a vehicle, a controller configured to operate an air-conditioning device, the controller further being configured to determine whether dust in the interior of the vehicle requires removal based on a signal from the dust sensor, and an air-conditioning device configured to remove or discharge dust from the air, the air-conditioning device being operated to activate a dust removal mode based on a signal from the controller and is configured to close an intake door to block inflow of external air into the interior of the vehicle and the air in the interior of the vehicle passes through an air filter and is circulated by a blower.

In an exemplary embodiment, before determining whether to operate the air-conditioning device to activate the dust removal mode based on the signal from the dust sensor, the controller may be configured to determine whether a driver may secure clear vision based on a measured value from a humidity sensor configured to sense humidity around a peripheral portion of an interior surface of a windshield in the vehicle. In response to determining, based on the measured value from the humidity sensor, that a driver is able secure a clear view, the controller may be configured to determine whether to activate the dust removal mode based on the signal from the dust sensor. In other words, in response to determining that the measured value from the humidity sensor is less than a predetermined reference value, at which the driver has difficulty in securing clear vision, the controller may be configured to determine whether to activate the dust removal mode based on the signal from the dust sensor.

In addition, based on the signal from the controller, the air-conditioning device may be configured to maintain an air-blowing level until the intake door is completely closed, and may be configured to increase the air-blowing level of the blower when the intake door is completely closed. When both concentration of dust particles having a diameter of about 10 μm or less and concentration of dust particles having a diameter of about 2.5 μm or less in the interior of the vehicle are as high as a value at which dust removal is required, the controller may be configured to turn ON an air conditioner of the air-conditioning device to prevent an increase in humidity in the interior of the vehicle.

Further, the controller may be configured to classify a level of concentration of dust in the air into four levels including a first level, a second level, a third level and a fourth level. In particular, the first level may indicate a lowest level of dust concentration, the fourth level may indicate a highest level of dust concentration, and the third level and the fourth level may indicate levels at which dust removal is required.

When at least one of the level of concentration of dust particles having a diameter of about 10 μm or less and the level of concentration of dust particles having a diameter of about 2.5 μm or less in the interior of the vehicle corresponds to the third level or the fourth level, the controller may be configured to operate the air-conditioning device to activate the dust removal mode. When both the level of concentration of dust particles having a diameter of about 10 μm or less and the level of concentration of dust particles having a diameter of about 2.5 μm or less in the interior of the vehicle correspond to the fourth level, the controller may be configured to turn ON an air conditioner of the air-conditioning device in the dust removal mode.

Additionally, when any one of the level of concentration of dust particles having a diameter of about 10 μm or less and the level of concentration of dust particles having a diameter of about 2.5 μm or less in the interior of the vehicle does not correspond to the fourth level, the controller may be configured to maintain an air conditioner at a current mode. The air-conditioning device may be configured to increase an air-blowing level of the blower based on the signal from the controller, and may be configured to turn ON an air conditioner to prevent an increase in humidity in the interior of the vehicle.

The automatic dust removal device for a vehicle may further include an outdoor dust sensor configured to sense concentration of outdoor dust, and in response to determining that the concentration of outdoor dust is high based on a measured value from the outdoor dust sensor, the controller may be configured to maintain the intake door in a closed state, and switch the blower and the air conditioner into previous modes. The automatic dust removal device for a vehicle may further include a global positioning system (GPS) disposed within the vehicle to detect a current position of the vehicle, and the controller may be configured to determine concentration of outdoor dust based on concentration data of dust by region, transmitted via wireless communication, and vehicle position data transmitted from the GPS, and in response to determining that the concentration of outdoor dust is high, the controller may be configured to maintain the intake door in a closed state, and switch the blower and the air conditioner into previous modes.

When both the level of concentration of dust particles having a diameter of about 10 μm or less and the level of concentration of dust particles having a diameter of about 2.5 μm or less in the exterior of the vehicle correspond to the third level or the fourth level, the controller may be configured to determine that the concentration of outdoor dust is high. In addition, the controller may be configured to detect a time taken for the air-conditioning device to operate to reactivate the dust removal mode, and when the time is less than a predetermined first reference time, the controller may be configured to determine that the concentration of outdoor dust is high, may be configured to maintain the intake door in a closed state, and switch the blower and the air conditioner into previous modes.

The controller may further be configured to recognize that the air conditioning device activated the dust removal mode through an increase in the air-blowing level while blocking outdoor air from being introduced into the interior of the vehicle by closing the intake door. Thereafter, the controller may be configured to detect time to be taken for the air conditioning device to reactivate the dust removal mode based on time to be taken for recognizing that the air conditioning device reactivates the dust removal mode. The controller may be configured to count the number of operations of the air-conditioning device to activate the dust removal mode during a predetermined second reference time, and when the number is greater than a predetermined critical value, the controller may be configured to determine that the concentration of outdoor dust is high, may be configured to maintain the intake door in a closed state, and switch the blower and the air conditioner into previous modes.

Furthermore, the automatic dust removal device for a vehicle may further include a dust concentration display unit configured to display alarm information based on a level of concentration of dust in the interior of the vehicle based on the signal from the controller. While the intake door is in a closed state to block inflow of external air, when carbon dioxide concentration is a predetermined reference value or greater, the controller may be configured to partially open the intake door to allow external air to flow into the interior of the vehicle.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a constitutional view illustrating an automatic dust removal device for a vehicle according to an exemplary embodiment of the present invention;

FIG. 2 is a flowchart illustrating an automatic dust removal method for a vehicle according to an exemplary embodiment of the present invention; and

FIG. 3 is a flowchart illustrating an automatic dust removal method for a vehicle according to another exemplary embodiment of the present invention.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

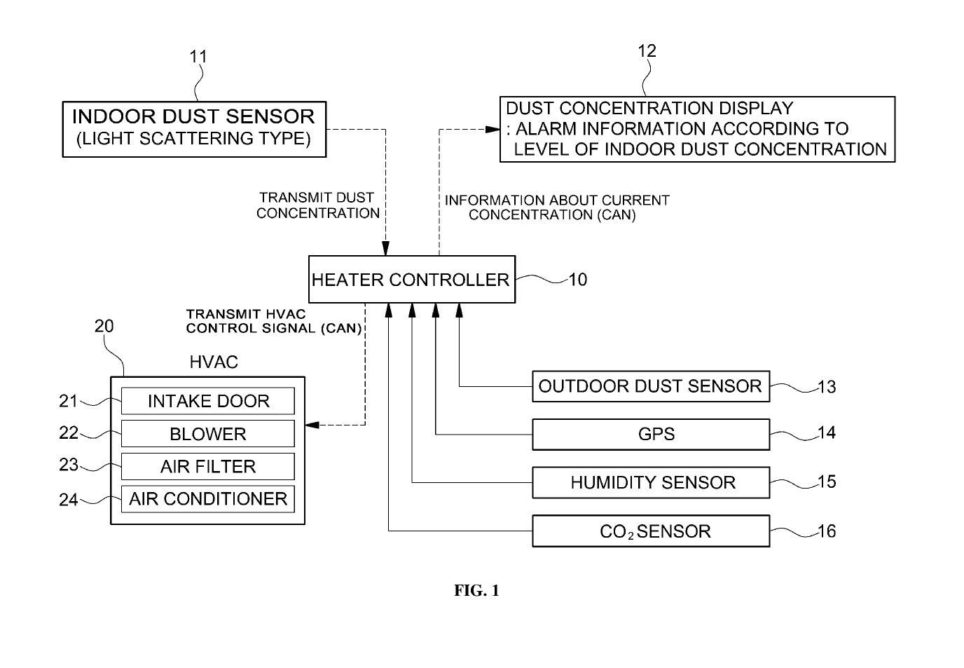

As shown in FIG. 1, an automatic dust removal device for a vehicle according to the present invention may include a dust sensor 11 configured to detect dust concentration in the interior of the vehicle, a controller 10 configured to operate an air-conditioning device (HVAC) 20 based on a signal from the dust sensor 11, a dust concentration display unit 12 configured to display the dust concentration in the interior of the vehicle based on a signal from the controller 10, and an outdoor dust sensor 13 configured to detect the outdoor dust concentration.

Particularly, the dust sensor 11 may be a senor configured to sense dust concentration in the interior of the vehicle using a light scattering method. The dust sensor 11 may be configured to transmit the sensed value of dust concentration to the controller 10. For example, although not shown in the drawings, a light-emitting part may be configured to emit light toward a light-receiving part, and the dust sensor 11 may be configured to measure the dust concentration by detecting light which is scattered by dust particles in the air present between the light-emitting part and the light-receiving part.

The controller 10 may be an existing controller mounted within a vehicle, for example, a heater controller of the air-conditioning device 20. When the controller 10 receives a dust concentration signal from the dust sensor 11, the controller 10 may be configured to operate an intake door (or an internal/external air switching door) 21, a blower (or a fan) 22, and an air conditioner (or a cooler) 24 of the air-conditioning device 20 based on the dust concentration signal, and may be configured to transmit a signal for the levels of dust concentration in the interior of the vehicle to the dust concentration display unit 12 via wired communication (controller area network (CAN) communication).

At least two levels, indicating respective predetermined ranges into which the values of dust concentration in the interior of the vehicle are classified, may be stored in the controller 10. Based on the signal transmitted from the dust sensor 11, the controller 10 may be configured to determine the level of dust concentration in the interior of the vehicle and transmit a signal associated therewith to the dust concentration display unit 12. The levels of dust concentration stored in the controller 10 may be variously set based on the vehicle environment.

According to the signal from the controller 10, the dust concentration display unit 12 may be configured to display information regarding current dust concentration in the interior of the vehicle (e.g., alarm information based on the level of dust concentration in the interior of the vehicle) to provide the driver or the passenger with information regarding the level of dust concentration in the interior of the vehicle in real time.

As is well known in the art, the air-conditioning device 20 of a vehicle includes an intake door 21 for selecting external air or internal air to be introduced into a duct. The intake door 21 may be configured to open or close an external air inlet aperture and an internal air inlet aperture in the duct, thereby selectively switching an external air mode or an internal air mode. In the external air mode, external air may be introduced into the interior of the vehicle and circulated by the blower 22. In the internal air mode, the introduction of external air into the interior of the vehicle may be prevented, and only internal air may be circulated by the blower 22.

As is also well known in the art, the air-conditioning device 20 of a vehicle includes an air filter 23, disposed in the duct for accepting air inflow, to remove foreign materials from the air. While the air introduced into the duct by vehicle-induced wind or by the operation of the blower 22 passes through the air filter 23, foreign materials, such as dust, may be removed from the air. The controller 10 may be configured to receive detection signals from a global positioning system (GPS) 14 configured to detect the current position of a vehicle, a humidity sensor 15 configured to detect humidity in the interior of the vehicle, and a carbon dioxide sensor 16 configured to detect carbon dioxide concentration in the interior of the vehicle.

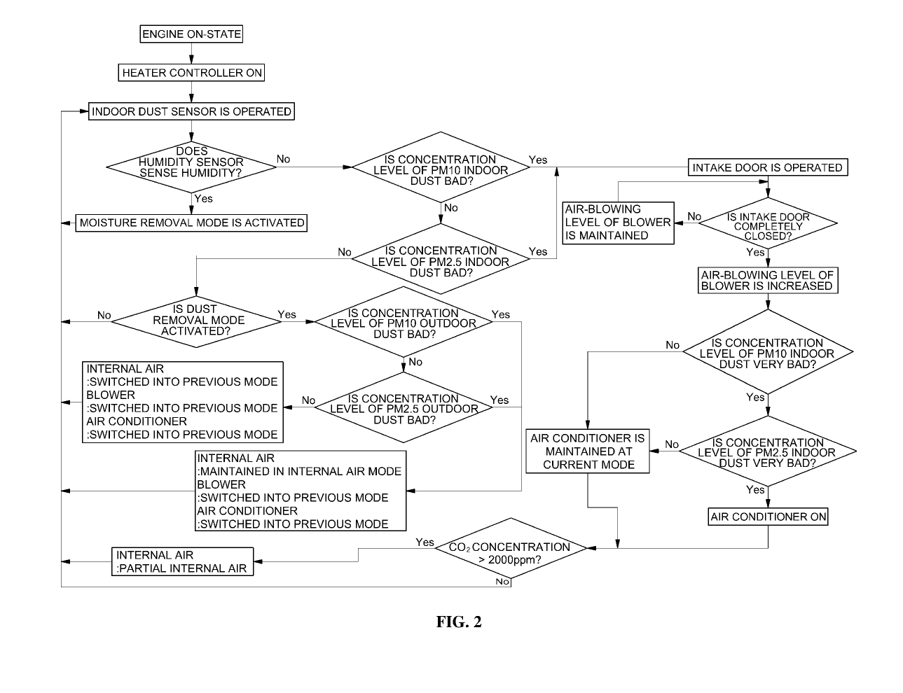

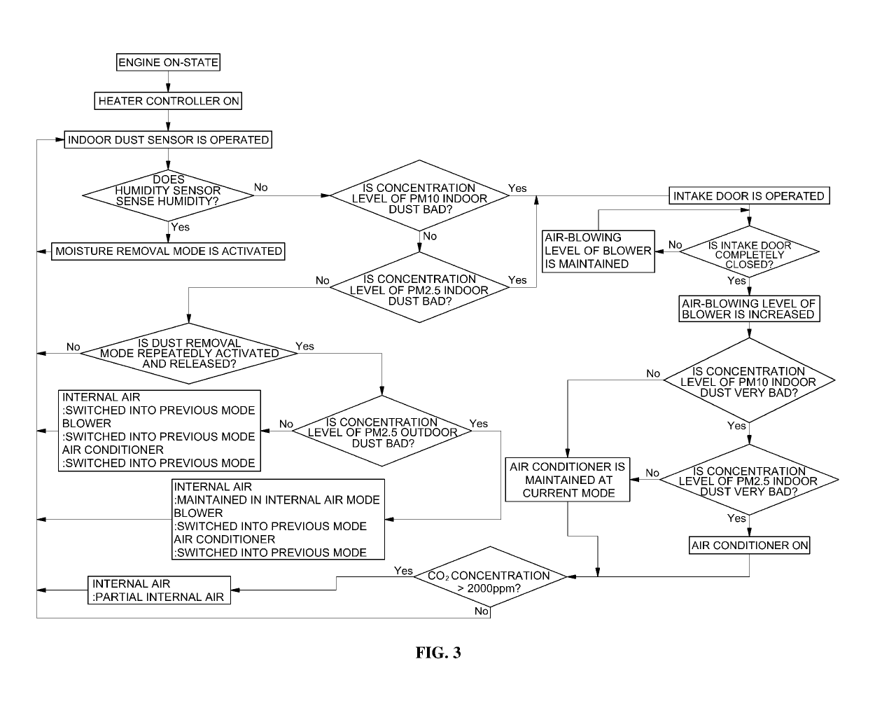

Hereinafter, an automatic dust removal method using the device of the present invention constituted as above will be explained with reference to FIGS. 2 and 3. Referring to FIG. 2, in an engine-on state, the dust sensor 11 may be configured to transmit information regarding the detected dust concentration in the interior of the vehicle to the controller 10.

Before determining whether a substantial amount of dust is present in the interior of the vehicle, the controller 10 may be configured to determine whether moisture is present on a peripheral portion of an interior surface of a windshield in the vehicle based on the value measured by the humidity sensor 15. When the humidity around the peripheral portion of the windshield, sensed by the humidity sensor 15, is a predetermined reference value or greater, a moisture removal mode for removing moisture from the interior of the vehicle may be activated. When the humidity around the peripheral portion of the windshield, sensed by the humidity sensor 15, is less than the predetermined reference value, the moisture removal mode may not be activated, and the controller 10 may be configured to determine whether to activate a dust removal mode based on a signal (measured value) from the dust sensor 11. Herein, the reference value is a value at which it is considered that the driver has difficulty in securing clear vision through the windshield. The reference value is typically set to a well-known value, or may be set to a value obtained from tests and experimentation.

To determine whether to activate the dust removal mode, is the controller may first be configured to determine whether the level of concentration (μg/m³) of dust particles having a diameter of about 10 μm or less (PM 10) corresponds to a “Bad” level (or range). When the level of concentration of dust particles of PM 10 corresponds to the “Bad” level, the dust removal mode may be activated. When the level of concentration of dust particles of PM 10 does not correspond to the “Bad” level, the controller may be configured to determine whether the level of concentration (μg/m³) of dust particles of PM 2.5 (about 2.5 μm or less in diameter) corresponds to a “Bad” level. When the level of concentration of dust particles of PM 2.5 corresponds to the “Bad” level, the dust removal mode may be activated and otherwise, the dust removal mode may be released.

To remove dust from the interior of the vehicle, the intake door 21 may be switched into the internal air mode. After determining that the intake door 21 has been completely closed, thereby blocking the inflow of external air, the air-blowing level of the blower 22 may be increased. When the air-blowing level of the blower 22 is increased and the intake door 21 is not completely closed, outdoor dust may enter the interior of the vehicle. Therefore, the air-blowing level of the blower 22 may be maintained at the current level until the intake door 21 is completely closed, and then may be increased after it is verified that the intake door 21 has been completely closed.

As the air-blowing level of the blower 22 increases, the speed at which air flows through the air filter 23 increases, and thus, dust in the interior of the vehicle may be removed rapidly. However, the noise level may also increase. Accordingly, the air-blowing level of the blower may be set appropriately to satisfy both the efficient removal of indoor dust and a favorable noise level. Such a suitable air-blowing level of the blower may be set to a value obtained from field tests and experimentation.

After the air-blowing level of the blower is increased, the controller 10 may be configured to determine whether to turn ON the air conditioner 24 based on fuel efficiency. The levels of dust concentration in the interior of the vehicle may be used to determine whether to turn ON the air conditioner. Particularly, when both the level of concentration of dust particles of PM 10 and the level of concentration of dust particles of PM 2.5 correspond to a “Very Bad” level, the air conditioner 24 may be turned ON. When either the level of concentration of dust particles of PM 10 or the level of concentration of dust particles of PM 2.5 does not correspond to a “Very Bad” level, the operation of the air conditioner may be maintained at the current mode. The operation of turning ON the air conditioner 24 may reduce the fuel efficiency, and does not have a remarkable indoor dust removal effect in comparison with the air filter 23. Therefore, by minimizing the conditions under which the air conditioner 24 is turned ON, fuel consumption attributable to the operation of the air conditioner may be minimized, which leads to improved fuel efficiency.

Further, the level of dust concentration in the interior of the vehicle may be variously set based on the environment and condition of the vehicle, and, for example, may be classified into the four levels shown in Table 1 below. Table 1 shows that the first level is a “Good” level, at which the dust concentration is low, the second level is a “Normal” level, at which the dust concentration is intermediate, the third level is a “Bad” level, at which the dust concentration is high, and the fourth level is a “Very Bad” level, at which the dust concentration is very high. The concentration range of each level may also change based on the environment and situation of the vehicle.

TABLE 1
[Unit: μg/m³]

| Classification | Good | Normal | Bad | Very Bad |
|---|---|---|---|---|
| PM 10 | 0~30 | 31~80 | 81~150 | 151~ |
| PM 2.5 | 0~15 | 16~50 | 51~100 | 101~ |

When the intake door 21 is completely closed and the air-blowing level of the blower 22 is increased, when it is intended to turn ON the air conditioner 24 to activate a moisture generation preventing mode, the air conditioner 24 may be turned ON without determining the level of indoor dust concentration. When the intake door 21 is completely closed and the inflow of external air is blocked, the indoor humidity may be increased. In particular, when the air conditioner 24 is operated, the indoor humidity may be decreased, and dust in the air passing through the air conditioner 24 may be removed by water generated by the latent heat of a heat exchanger provided in the air conditioner 24, thereby realizing a pleasant or user desired indoor environment. In other words, when the air conditioner is turned ON, moisture generation, which may occur in the interior of the vehicle due to switching of the intake door 21 into the internal air mode to remove dust, may be prevented, and further, dust in the air passing through the air conditioner 24 may be removed. As a result, a more pleasant air may be provided than when the air conditioner 24 is in the OFF state.

While the dust removal mode is operated, when it is intended to turn ON the air conditioner 24 to activate the moisture generation preventing mode, that is, when it is intended to suppress an increase in indoor humidity of the vehicle, the air conditioner 24 may be turned ON unconditionally. When the dust removal mode is activated and the intake door 21 is switched into the internal air mode, the concentration of carbon dioxide (CO₂) in the interior of the vehicle may increase. In particular, the intake door 21 may be partially opened to reduce the carbon dioxide concentration in the interior of the vehicle.

In other words, when the carbon dioxide concentration in the interior of the vehicle is a predetermined reference value or greater, the intake door 21 may be partially opened to allow external air to flow into the interior of the vehicle. The reference value may be set to a typical value, or may be set to a value, determined through tests and experimentation, at which it is considered that ventilation is required due to the high carbon dioxide concentration in the interior of the vehicle. This reference value may be variously changed based on the environment and situation of the vehicle.

Moreover, based on the signals (measured values) from the humidity sensor 15 and the dust sensor 11, the controller 10 may be configured to again determine whether to activate the dust removal mode. When the humidity around the peripheral portion of the windshield, sensed by the humidity sensor 15, is less than the predetermined reference value and the moisture removal mode is not activated, to determine whether to reactivate the dust removal mode, the level of dust concentration in the interior of the vehicle may be determined based on the signal (measured value) from the dust sensor.

When the measured value from the dust sensor 11 satisfies the determination condition, the dust removal mode may be reactivated, and the above-described steps for removing the indoor dust may be performed. When the measured value from the dust sensor 11 does not satisfy the determination condition, the controller 10 may be configured to determine whether to switch the intake door 21 from the internal air mode to the external air mode. In particular, when both the level of concentration of dust particles of PM 10 and the level of concentration of dust particles of PM 2.5 are less than the “Bad” level (third level), that is, correspond to the “Good” level (first level) or the “Normal” level (second level), the controller 10 may be configured to determine whether the intake door 21 is required to be switched from the internal air mode to the external air mode. In other words, after the air-conditioning device 20 activates the dust removal mode, when the level of dust concentration in the interior of the vehicle is less than the third level, the controller 10 may be configured to determine whether it is necessary to switch the intake door 21 into the external air mode.

As shown in FIG. 2, in response to determining that the dust removal mode has been activated, the controller 10 may be configured to determine whether it is necessary to switch the mode of the intake door 21 using a signal from the outdoor dust sensor 13 and/or data (e.g., current position data of the vehicle) from the global positioning system (GPS) 14. When the level of concentration of outdoor dust of PM 10, sensed by the outdoor dust sensor 13, is the “Bad” level or worse, in other words, when at least one of the level of concentration of outdoor dust of PM 10 and the level of concentration of outdoor dust of PM 2.5 is the “Bad” level (third level) or worse, that is, when at least one of the level of concentration of outdoor dust of PM 10 and the level of concentration of outdoor dust of PM 2.5 is the “Bad” level (third level) or the “Very Bad” level (fourth level), the internal air mode may be maintained, in which the intake door 21 may be completely closed, to block the inflow of external air, and the blower 22 and the air conditioner 24 may be switched into the previous modes.

Further, when both the level of concentration of outdoor dust of PM 10 and the level of concentration of outdoor dust of PM 2.5 are less than the “Bad” level (third level), that is, when the level of concentration of outdoor dust of PM 10 and the level of concentration of outdoor dust of PM 2.5 are the “Good” level (first level) or the “Normal” level (second level), the intake door 21, the blower 22 and the air conditioner 24 may all be switched into the previous modes. In other words, in response to determining that the dust concentration in the interior of the vehicle has been reduced by the operation of the dust removal mode, the intake door 21 may not be immediately switched into the external air mode, and the controller 10 may be configured to determine whether to switch the mode of the intake door 21 based on the detected concentration of outdoor dust. In particular, when the indoor dust concentration has been reduced, the controller 10 may be configured to determine whether to switch the mode of the intake door 21 by detecting the outdoor environment based on the level of outdoor dust concentration.

When the intake door 21 is switched into the external air mode, that is, the intake door 21 is opened when the outdoor dust concentration is greater than a predetermined value, external dust may be introduced into the interior of the vehicle, which may cause frequent repetition of the operation state and the operation-released state of the dust removal mode. Accordingly, the moment at which the intake door 21 is switched into the external air mode may be determined by detecting the outdoor environment based on the external dust concentration data.

As described above, the external dust concentration data is based on the signal (measured value) from the outdoor dust sensor 13 mounted to the exterior of the vehicle or the dust concentration value by region, transmitted via wireless communication. The controller 10 may be configured to detect the position data of the vehicle using the GPS 14, and determine the external dust concentration and the concentration level based on the dust concentration value in the region in which the vehicle is currently positioned.

As described above, when at least one of the level of concentration of outdoor dust of PM 10 and the level of concentration of outdoor dust of PM 2.5 is the “Bad” level (third level) or the “Very Bad” level (fourth level), the internal air mode may be maintained, in which the intake door 21 may be completely closed, and only the blower 22 and the air conditioner 24 may be switched into the previous modes. Further, as shown in FIG. 3, it may be possible to determine whether to switch the mode of the intake door 21 in an indirect way. Accordingly, the controller 10 may be configured to determine whether to switch the mode of the intake door 21 by detecting whether the dust removal mode is repeatedly activated and released.

When the vehicle is not equipped with the outdoor dust sensor 13 and the GPS 14 and is not capable of receiving the dust concentration value in the region in which the vehicle is currently positioned using wireless communication, and in response to determining that the dust removal mode has been repeatedly activated and released over a predetermined period of time, it may be assumed that the outdoor dust concentration is high. Accordingly, the dust removal mode may not be immediately released, the intake door 21 may be maintained in the internal air mode, and only the blower 22 and the air conditioner 24 may be switched into the previous modes.

In response to determining that the dust removal mode has not been repeatedly activated and released over a predetermined period of time, it may be assumed that the outdoor dust concentration is low. Accordingly, the dust removal mode may be released, and the intake door 21, the blower 22 and the air conditioner 24 may all be switched into the previous modes. To release the dust removal mode in the indirect way described above, the controller 10 may be configured to detect the time taken for the air-conditioning device 20 to operate to reactivate the dust removal mode using a clock or timer mounted within the controller 10.

For example, in response to determining that the intake door 21 is completely closed to activate the internal air mode and the air-blowing level of the blower is increased, the controller 10 may be configured to determine that the air-conditioning device 20 is operated to activate the dust removal mode, and then may be configured to detect the time taken for the air-conditioning device 20 to operate again to reactivate the dust removal mode using the clock disposed therein. Accordingly, the time taken for the air conditioning device 20 to reactivate the dust removal mode may be confirmed.

When the time taken for the air-conditioning device 20 to operate to reactivate the dust removal mode is equal to or less than a predetermined first reference time, the controller 10 may be configured to determine that the outdoor dust concentration is high. To release the dust removal mode, the controller 10 may be configured to detect the number of times that the dust removal mode was activated during a predetermined period of time using the clock and the counter disposed therein.

For example, in response to determining that the intake door 21 is completely closed to activate the internal air mode and the air-blowing level of the blower is increased, the controller 10 may be configured to determine that the air-conditioning device 20 is operated to activate the dust removal mode, and then may be configured to count the number of times that the dust removal mode was activated. When the number of times that the dust removal mode was activated, counted by the counter during a predetermined second reference time, is equal to or greater than a predetermined critical value, it may be assumed that the outdoor dust concentration is high. At this time, the dust removal mode may not be immediately released, the intake door 21 may be maintained in the internal air mode, and only the blower 22 and the air conditioner 24 may be switched into the previous modes. The counter disposed within the controller 10 may be configured to accumulate the counted number of times that the dust removal mode was activated until it is reinitialized.

As is apparent from the above description, the present invention provides an automatic dust removal device for a vehicle, which constantly senses dust in the interior of the vehicle and automatically removes the detected dust, thereby improving the purity of the air in the passenger compartment of the vehicle. Further, by minimizing the conditions under which an air conditioner is turned ON, fuel consumption attributable to the dust removal operation may be minimized.

Furthermore, after the dust is removed from the interior of the vehicle, the moment at which the air flow mode switches from an internal air mode to an external air mode may be determined based on external dust concentration, thereby preventing the inflow of outdoor dust into the interior of the vehicle. In addition, when an intake door is switched into an internal air mode to remove dust, the air-blowing level of a blower for air circulation may be prevented from being increased before the intake door for inducing external air is completely closed, thereby removing the cause of inflow of outdoor dust into the interior of the vehicle and improving dust removal efficiency.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. An automatic dust removal device for a vehicle, comprising:
a dust sensor configured to sense dust concentration in an interior of a vehicle;
a controller configured to operate an air-conditioning device and determine whether dust in the interior of the vehicle requires removal based on a signal from the dust sensor; and
an air-conditioning device configured to remove dust from the air is operated to activate a dust removal mode based on a signal from the controller and an intake door is closed to block inflow of external air into the interior of the vehicle and the air in the interior of the vehicle passes through an air filter and is circulated by a blower.

2. The automatic dust removal device for a vehicle of claim 1, wherein, before determining whether to operate the air-conditioning device to activate the dust removal mode based on the signal from the dust sensor, the controller is configured to determine whether a clear vision is possible based on a measured value from a humidity sensor configured to sense humidity around a peripheral portion of an interior surface of a windshield in the vehicle.

3. The automatic dust removal device for a vehicle of claim 2, wherein, in response to determining that the measured value from the humidity sensor is less than a predetermined reference value, at which securing clear vision is difficult, the controller is configured to determine whether to activate the dust removal mode based on the signal from the dust sensor.

4. The automatic dust removal device for a vehicle of claim 1, wherein, based on the signal from the controller, the air-conditioning device is configured to maintain an air-blowing level of the blower until the intake door is completely closed, and increase the air-blowing level of the blower when the intake door is completely closed.

5. The automatic dust removal device for a vehicle of claim 1, wherein, when both concentration of dust particles having a diameter of about 10 μm or less and concentration of dust particles having a diameter of about 2.5 μm or less in the interior of the vehicle are as high as a value at which dust removal is required, the controller is configured to turn ON an air conditioner of the air-conditioning device to prevent an increase in humidity in the interior of the vehicle.

6. The automatic dust removal device for a vehicle of claim 1, wherein the controller is configured to classify a level of concentration of dust in the air into four levels.

7. The automatic dust removal device for a vehicle of claim 6, wherein, when at least one of the level of concentration of dust particles having a diameter of about 10 μm or less and the level of concentration of dust particles having a diameter of about 2.5 μm or less in the interior of the vehicle corresponds to the third level or the fourth level, indicating levels at which dust removal is required, the controller is configured to operate the air-conditioning device to activate the dust removal mode.

8. The automatic dust removal device for a vehicle of claim 6, wherein, when both the level of concentration of dust particles having a diameter of about 10 μm or less and the level of concentration of dust particles having a diameter of about 2.5 μm or less in the interior of the vehicle correspond to the fourth level, indicating the highest level of dust concentration, the controller is configured to turn ON an air conditioner of the air-conditioning device in the dust removal mode.

9. The automatic dust removal device for a vehicle of claim 6, wherein, when any one of the level of concentration of dust particles having a diameter of about 10 μm or less and the level of concentration of dust particles having a diameter of about 2.5 μm or less in the interior of the vehicle does not correspond to the fourth level, the controller is configured to maintain an air conditioner at a current mode.

10. The automatic dust removal device for a vehicle of claim 1, wherein the air-conditioning device is configured to increase an air-blowing level of the blower based on the signal from the controller, and turn ON an air conditioner to prevent an increase in humidity in the interior of the vehicle.

11. The automatic dust removal device for a vehicle of claim 6, further comprising:
an outdoor dust sensor configured to sense concentration of outdoor dust,
wherein in response to determining that the concentration of outdoor dust is high based on a measured value from the outdoor dust sensor, the controller is configured to maintain the intake door in a closed state, and switch the blower and the air conditioner into previous modes.

12. The automatic dust removal device for a vehicle of claim 6, further comprising:
a global positioning system (GPS) disposed within the vehicle to detect a current position of the vehicle,
wherein the controller is configured to determine concentration of outdoor dust based on concentration data of dust by region, transmitted via wireless communication, and vehicle position data transmitted from the GPS, and
in response to determining that the concentration of outdoor dust is high, the controller is configured to maintain the intake door in a closed state, and switch the blower and the air conditioner into previous modes.

13. The automatic dust removal device for a vehicle of claim 11, wherein, when both the level of concentration of dust particles having a diameter of about 10 μm or less and the level of concentration of dust particles having a diameter of about 2.5 μm or less in the exterior of the vehicle correspond to the third level or the fourth level, the controller is configured to determine that the concentration of outdoor dust is high.

14. The automatic dust removal device for a vehicle of claim 1, wherein the controller is configured to detect a time taken for the air-conditioning device to operate to reactivate the dust removal mode, and when the time is equal to or less than a predetermined first reference time, the controller is configured to determine that the concentration of outdoor dust is high, maintain the intake door in a closed state, and switch the blower and the air conditioner into previous modes.

15. The automatic dust removal device for a vehicle of claim 1, wherein the controller is configured to count the number of operations of the air-conditioning device to activate the dust removal mode during a predetermined second reference time, and when the number is equal to or greater than a predetermined critical value, the controller is configured to determine that the concentration of outdoor dust is high, maintain the intake door in a closed state, and switch the blower and the air conditioner into previous modes.

16. The automatic dust removal device for a vehicle of claim 1, further comprising:
a dust concentration display unit configured to display alarm information based on a level of concentration of dust in the interior of the vehicle based on the signal from the controller.

17. The automatic dust removal device for a vehicle of claim 1, wherein, while the intake door is in a closed state to block inflow of external air, when carbon dioxide concentration is a predetermined reference value or greater, the controller is configured to partially open the intake door to allow external air to flow into the interior of the vehicle.
